(19) United States
(12) Patent Application Publication
(10) Pub. No.: US 2026/0338094 A1
(43) Pub. Date: Oct. 29, 2026

(54) EXHAUST-GAS AFTERTREATMENT SYSTEM

(71) Applicant: DAIMLER TRUCK AG, Leinfelden-Echterdingen (DE)

(72) Inventors: Mirco CONITZ, Stuttgart (DE); Melanie LÜCKE, Leinfelden-Echterdingen (DE); Carlo SCHUHMANN, Leinfelden-Echterdingen (DE)

(21) Appl. No.: 19/135,441

(22) PCT Filed: Nov. 29, 2023
(86) PCT No.: PCT/EP2023/083567

§ 371 Date: Jun. 4, 2025

(30) Foreign Application Priority Data
Dec. 5, 2022 (DE) 10 2022 132 207.6

(51) Int. Cl. F01N 3/20; B01D 53/94; F01N 3/021; F01N 3/10

(52) U.S. Cl. CPC F01N 3/2066; B01D 53/9459; F01N 3/021; F01N 3/106; F01N 3/2006; B01D 2257/40; B01D 2257/406; B01D 2257/702; B01D 2258/01; F01N 2610/1453

(57) ABSTRACT

An exhaust-gas aftertreatment system for treating an exhaust-gas stream from combustion in an internal combustion engine includes a first dosing device configured to add a first additive into the exhaust-gas stream and a heating device arranged downstream and configured to introduce the thermal energy. Further downstream there is an oxidation catalyst to oxidize nitrogen, carbon, and hydrogen compounds contained in the exhaust gases.

### BACKGROUND AND SUMMARY OF THE INVENTION

Exemplary embodiments of the invention relate to an exhaust-gas aftertreatment system to treat an exhaust-gas stream resulting from the combustion in an internal combustion engine.

The exhaust gases emitted by internal combustion engines consist of a heterogeneous mixture which contains, for example, gaseous emissions of carbon monoxide (CO), unburned hydrocarbons (HC), and nitrogen oxides (NOx), as well as materials in condensed phase that can form particulate matter. In an engine exhaust system, for example in a diesel engine, catalyst systems are therefore provided to convert certain or all of these exhaust-gas constituents into non-restricted exhaust gas constituents and to filter them out.

Known exhaust-gas aftertreatment systems usually consist of an oxidation catalyst (DOC), a particle filter (DPF), and a selective reduction catalyst (SRC), arranged in this order. Similarly, the elements can be arranged in precisely the reverse order, for example.

For instance, DE 10 2012 209 197 B4 discloses an exhaust-gas aftertreatment system, which comprises an electrically heated catalyst device, an oxidation catalyst device, a hydrocarbon adsorber, and a control module.

EP 3 111 067 B1 describes an exhaust-gas aftertreatment system, comprising a first oxidation catalyst for the oxidation of compounds such as nitrogen, carbon, and hydrogen, and comprising a first dosing device, which is arranged downstream of the first oxidation catalysts and is designed to discharge a first additive into the exhaust-gas stream. Furthermore comprised is a reduction catalyst device which is arranged downstream of the first dosing device and reduces nitric oxides in the exhaust-gas stream by means of the first additive. This same arrangement is arranged again downstream of the first reduction catalyst device, wherein a second additive is used instead of the first additive.

DE 10 2008 026 191 A1 describes an exhaust-gas aftertreatment system and a method for particle and nitric oxide reduction. The exhaust-gas aftertreatment device comprises a particle filter and an NOx adsorber and an SCR catalyst connected downstream of the NOx adsorber in the exhaust-gas flow direction. By supplying heated exhaust gas to the NOx adsorber of the SCR catalyst, the light-off temperature is reached at an earlier point in time here than the NOx adsorber reaches the desorption temperature.

US 2008/0264042 A1 discloses a method for reducing NOx in exhaust gases generated by an internal combustion engine. The method comprises activating a heat source if the exhaust gases lie below a certain temperature. Furthermore, this method comprises injecting a reducing agent into the segment of the exhaust path before the SCR catalyst, in order to react in the segment with NOx in the exhaust gases.

DE 10 2014 105 043 A1 discloses an exhaust-gas aftertreatment system for an internal combustion engine, which has an exhaust-gas line, a first injection direction in fluid communication with the exhaust-gas line configured to selectively inject fuel containing unburned hydrocarbon (HC) into the exhaust-gas line, and an oxidation catalyst arranged in the exhaust-gas line downstream of the first injection device. The system comprises a catalyst for hydrocarbon selective catalytic reduction (HC-SCR), which is applied to the oxidation catalyst, a heating device positioned on an upstream side of the oxidation catalyst and configured to heat oxidation catalyst and the HC-SCR catalyst.

The exhaust-gas aftertreatment systems must comply with Euro-VI legislation in accordance with current standards. Even lower exhaust-gas limit values are being discussed for future standards, such as Euro-VII and higher. Particularly in the case of a cold start, known exhaust-gas aftertreatment systems are therefore in need of considerable performance improvements. Future aftertreatment systems must therefore comply with the prescribed emission parameters, which relate in particular to NOx, NO2, NH3, and PN values.

Exemplary embodiments of the present invention are directed to an exhaust-gas aftertreatment system which can fulfil the aforementioned requirements.

At the core of the exhaust-gas aftertreatment system according to the invention is a first dosing device designed to add a first additive to the exhaust-gas stream, wherein a heating device is comprised which is arranged downstream and is designed to introduce thermal energy, and further downstream there is an oxidation catalyst which is designed to oxidize nitrogen, carbon and hydrogen compounds contained in the exhaust gases.

The exhaust-gas aftertreatment system is used to treat an exhaust-gas stream resulting from the combustion in an internal combustion engine and can, for example, comply with future exhaust-gas legislation, such as in particular Euro-VII. Particularly in the case of a cold start, the exhaust-gas aftertreatment system according to the invention can achieve a considerable increase in performance relative to known systems. This can be achieved in particular by the arrangement of the elements, i.e., the first dosing device, the heating device, and the oxidation catalysts, specifically downstream in this order.

In this case, the heating device is an electric heater or an electrically heated oxidation catalyst. If the heating device is designed as an electric heater, the NO2/NOx ratio, the HC light-off, the SCR light-off, and the urea preparation can be improved, for example. Instead of an electric heater, an electrically heated oxidation catalyst can also be used. The aforementioned oxidation catalyst can be used for this. This can likewise give off thermal energy. Furthermore, the electrically heated oxidation catalyst can be used for the oxidation of compounds consisting of nitrogen, carbon, and hydrogen in the exhaust gas.

The invention significantly improves the cold start emission performance, while simultaneously requiring minimal installation space. The core idea is therefore the arrangement and positioning of heating, dosing, and catalyst devices, in order to achieve the maximum overall system performance. Overall, therefore, an exhaust-gas aftertreatment system is proposed enabling rapid heating of all components in the case of a cold start. In this case, in particular, an NOx reduction can be achieved. Advantageously, at the same time, it is possible to maintain low PN values and low secondary emissions, such as in particular NH3 and NO2.

The first additive can be, for example, a HC hydrocarbon. Other substances or substance mixtures are also conceivable.

In one advantageous embodiment, the electrically heated oxidation catalyst can additionally or alternatively be used as a poison trap, wherein in particular chemical elements can lead to deactivation of the catalytic surface can be collected.

In accordance with a very advantageous refinement of the idea, it can be provided that a second dosing device is connected downstream of the oxidation catalyst and is designed to supply a second additive to the exhaust-gas stream. The second additive can be, for example, a urea solution. Other solutions, substances or substance mixtures are also conceivable.

It can be provided in accordance with an advantageous design that a first selective reduction catalyst is arranged after the second dosing device. The first selective reduction catalyst can be used to reduce nitrogen oxides NOx in the exhaust-gas stream, in particular when using a urea solution as second additive.

In accordance with a very advantageous refinement of the idea, it can be provided that a first slip catalyst, which is used to oxidize additive residues and/or to support the first reduction catalyst, is arranged after the first selective reduction catalyst. Due to the first slip catalyst, for example, NH3 slip can oxidize. The oxidation of additive residues and/or the support of the first reduction catalyst can be achieved by additional reduction of nitrogen oxides NOx in the exhaust-gas stream.

It can be provided in accordance with an advantageous design that the second additive is supplied as a function of a diesel particle filter temperature. As a result, sufficient NO2 can be provided, in particular for a passive regeneration.

In accordance with a very advantageous refinement of the idea, it can be provided that the first slip catalyst is arranged downstream of a particle filter which is designed to retain and/or to oxidize soot particles. By way of example, an oxidation layer, which can be applied to the particle filter, can an exothermic reaction lead to a soot regeneration and/or to a desulphurization of the subsequent catalysts. Advantageously, a sufficient NO2/NOx ratio is provided for an NO2-based soot regeneration and/or NOx reduction at any subsequent SCR catalysts.

It can be provided in accordance with an advantageous design that a third dosing device is connected downstream of the particle filter and is designed to supply a third additive to the exhaust-gas stream. The third additive can be a urea solution. Other solutions, substances or substance mixtures are also conceivable.

According to a very advantageous refinement of the idea, it can provided that a second selective reduction catalyst is arranged after the third dosing device. As a result, a reduction of nitrogen oxides NOx in the exhaust-gas stream can be achieved, in particular when using the second and/or third additive.

It can be provided in accordance with an advantageous design that a second slip catalyst, which is used to oxidize additive residues and/or to support the first reduction catalyst, is arranged after the second selective reduction catalyst. As a result, NH3 slip can advantageously oxidize.

### BRIEF DESCRIPTION OF THE DRAWING FIGURES

Further advantageous designs of the exhaust-gas aftertreatment system according to the invention will become apparent from the exemplary embodiment which is presented in more detail hereinafter with reference to the figures, in which:

FIG. 1 shows a schematic illustration of a possible embodiment of the exhaust-gas aftertreatment system;

FIG. 2 shows a further schematic illustration of a possible embodiment of the exhaust-gas aftertreatment system.

### DETAILED DESCRIPTION

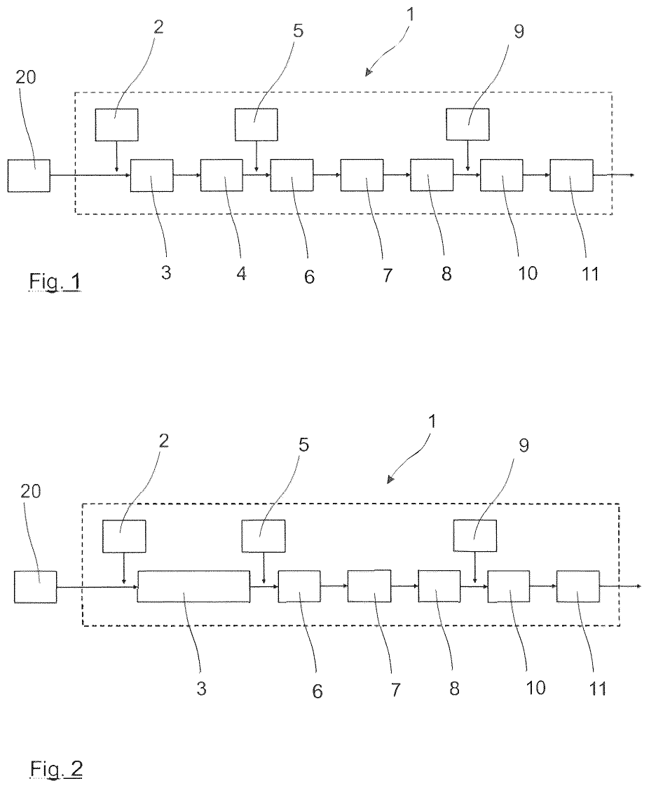

The illustration of FIG. 1 shows a possible embodiment of the exhaust-gas aftertreatment system 1 in a schematic illustration. The exhaust-gas aftertreatment system 1 is designed to treat an exhaust-gas stream resulting from the combustion in an internal combustion engine 20. To this end, a first dosing device 2 is provided, which is used to discharge a first additive into the exhaust-gas stream. Provided downstream is a heating device 3 to supply the system with thermal energy and in particular due to a NO2/NOx-ratio to improve the HC light-off, the SRC light-off, and/or the urea preparation.

Provided further downstream is an oxidation catalyst 4, which is used to oxidize nitrogen, carbon, and hydrogen compounds in the exhaust gas. The oxidation catalyst 4 can additionally be used as a poison trap to collect chemical elements that could lead to a deactivation of the catalytic surface.

A second dosing device 5 can be arranged further downstream, specifically after the first oxidation catalyst 4. The second dosing device 5 is used, in particular, to supply a second additive to the exhaust-gas stream. The second additive can be, for example, a urea solution. Other substances, solutions or compositions are likewise conceivable as second additive.

A first selective reduction catalyst 6 can be arranged further downstream, specifically after the second dosing device 5. The first selective reduction catalyst 6 is used to reduce nitrogen oxides NOx in the exhaust-gas stream, and specifically when using a second additive. The second additive can likewise contain a urea solution, or another solution.

A first slip catalyst 7 can be arranged further downstream, in particular in order to oxidize NH3 slip. The slip catalyst 7 is used, in particular, to oxidize an additive residue and/or to support the first reduction catalyst 6 by an additional reduction of nitrogen oxides in the exhaust-gas stream. Furthermore, a controller for the addition of the second additive as a function of a diesel particle filter temperature (DPF temperature) can be provided, in order to supply enough NO2 for passive regeneration.

According to the illustrated embodiment, a particle filter 8 can furthermore be arranged downstream of the first slip catalyst 7. This is designed in particular to retain and/or to oxidize soot particles. Furthermore, an oxidizing coating can be applied to the particle filter 8 in order to generate an exothermic reaction for soot regeneration and desulphurization of the subsequent catalysts. Advantageously, this also provides a sufficient NO2/NOx ratio for NO2-based soot regeneration and/or NOx reduction at the subsequent SCR catalysts.

A third dosing device 9 can be provided further downstream to discharge a third additive into the exhaust-gas stream. The third additive can likewise be a urea solution, or else another solution or composition.

A second selective reduction catalyst 10 can be arranged downstream of the third dosing device 9. This is used in particular to reduce nitrogen oxides in the exhaust-gas stream when using the second and/or the third additive.

A second slip catalyst 11 can be provided further downstream to oxidize NH3 slip. The second slip catalyst 11 is provided in particular to oxidize additive residues and/or to support the second reduction catalyst 10 by an additional reduction of nitrogen oxides NOx in the exhaust-gas stream.

A further design variant of the exhaust-gas aftertreatment system 1 can be seen in FIG. 2. The same elements are provided here with the same reference signs, so that they do not need to be discussed in further detail. In contrast to FIG. 1, an electrically heated oxidation catalyst is provided here as heating device 3, and specifically instead of an electric heater and an oxidation catalyst 4. This electrically heated oxidation catalyst can also be used as a poison trap to collect chemical elements which can lead to deactivation of the catalytic surface.

Of course, the described design variants of the exhaust-gas aftertreatment system 1 in the FIGS. 1 and 2 can also be modified in line with the invention, thus giving rise to various options that enable rapid heating of the exhaust-gas aftertreatment system 1 in the case of a cold start.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. An exhaust-gas aftertreatment system configured to treat an exhaust-gas stream from combustion in an internal combustion engine, the exhaust-gas aftertreatment system comprising:
a first dosing device configured to add a first additive to the exhaust-gas stream;
a heating device arranged downstream of the first dosing device and configured to introduce thermal energy to the exhaust-gas stream; and
an oxidation catalyst downstream of the heating device and configured to oxidize nitrogen, carbon, and hydrogen compounds contained in the exhaust-gas stream,
wherein the heating device is an electric heater connected directly upstream of the oxidation catalyst or the heating device is an electrically heatable oxidation catalyst.

12. The exhaust-gas aftertreatment system of claim 11, further comprising:
a second dosing device connected downstream of the oxidation catalyst and configured to supply a second additive to the exhaust-gas stream.

13. The exhaust-gas aftertreatment system of claim 12, further comprising:
a first selective reduction catalyst arranged after the second dosing device.

14. The exhaust-gas aftertreatment system of claim 13, further comprising:
a first slip catalyst, configured to oxidize additive residues or to support the first selective reduction catalyst, is arranged after the first selective reduction catalyst.

15. The exhaust-gas aftertreatment system of claim 12, wherein the second dosing device is configured to supply the second additive as a function of a diesel particle filter temperature.

16. The exhaust-gas aftertreatment system of claim 14, further comprising:
a particle filter configured to retain or oxidize soot particles and connected downstream of the first slip catalyst.

17. The exhaust-gas aftertreatment system of claim 16, wherein the particle filter includes an oxidation layer, wherein a exothermic reaction leads to soot regeneration or desulphurization of subsequent catalysts.

18. The exhaust-gas aftertreatment system of claim 16, further comprising:
a third dosing device connected downstream of the particle filter and configured to supply a third additive to the exhaust-gas stream.

19. The exhaust-gas aftertreatment system of claim 18, further comprising:
a second selective reduction catalyst arranged after the third dosing device.

20. The exhaust-gas aftertreatment system of claim 19, further comprising:
a second slip catalyst configured to oxidize additive residues or to support the first selective reduction catalyst and arranged after the second selective reduction catalyst.
